(19) United States
(12) Patent Application Publication
(10) Pub. No.: US 2006/0071383 A1
(43) Pub. Date: Apr. 6, 2006

(54) Method and apparatus for placement of movable jig stops

(75) Inventors: Danny L. Rupe, Colleyville, TX (US); Kenneth T. George, Irving, TX (US)

Correspondence Address: CRUTSINGER & BOOTH, 1601 ELM STREET, SUITE 1950, DALLAS, TX, 752014744, US

(73) Assignee: Alpine Engineered Products, Inc., Pompano Beach, FL (US)

(21) Appl. No.: 10/958,790

(22) Filed: Oct. 5, 2004

(51) Int. Cl. B25B 1/20

(52) U.S. Cl. 269/37

(57) ABSTRACT

A jig stop placement assembly is presented for use with a truss assembly table having a plurality of jig assembly slots extending laterally across the table top. Jig stop assemblies are movable along the jig assembly slots and can be clamped into a desired location. An energy-emitting distance measuring device determines the distance between the jig stop and a reference piece or point. The energy-emitting device is preferably a laser device capable of emitting a laser beam. The measurement device provides information regarding the distance between the jig stop and the reference piece which enables the user to accurately place the jig stop in a desired location. The jig stop placement assembly preferably includes alignment mechanisms for positioning the assembly into a predetermined relationship with a jig stop, the truss assembly table, the reference piece or any combination thereof.

### TECHNICAL FIELD

The present invention relates generally to an apparatus and method for assembling wood trusses for the building trade. The invention relates more particularly to a method and apparatus for accurate placement of movable jib stops on a truss assembly table.

### BACKGROUND

Prefabricated wood trusses have made modern construction of buildings faster and more efficient. The wood trusses are assembled in factories equipped with machinery for mass-fabricating the individual truss components, which are assembled on large truss assembly tables. The completed trusses are then shipped to the construction site ready for use in the building. The specifications for the truss designs can be practically limitless. A particularly time-consuming task of truss construction is the set-up or jigging process in which jig stops are positioned on a truss table into positions in which they hold truss members in the proper position and orientation for subsequent attachment. Each set of truss members is precut to the proper length and end angle, but must be arranged on a truss table in the correct truss configuration prior to being fixed into that configuration with truss jigging plates.

Because set-up can be so time consuming, often a jigging system is used to hasten the set-up process. A set-up system typically includes a number of movable jig stops which are positioned on the truss table in a pattern that defines the proper placement of planks on the table. The positions of the jigs are usually predetermined for the truss manually or by a software program associated with the set-up system. The planks are then arranged on the table, with their positions and relative orientations being defined by the positions of the set-up jigs.

Once the jig stops are properly positioned, the truss members are attached to one another by a pressure roller or hydraulic press which presses a truss connector plate into adjoining planks to form the truss. The movable jig stops must be quickly, but accurately, placed into position. The ease of set-up to accurately position the jig stops of the truss assembly apparatus becomes a critical factor in the manufacturing process. Several methods have been used for accurate placement of jig stops on a truss assembly table.

One type of jig stop placement apparatus is described in U.S. Pat. No. 4,943,038 issued Jul. 24, 1990 to Harnden which is incorporated herein by reference in its entirety. Harnden describes a truss assembly apparatus with a table composed of several similar table sections, each having a plurality of elongated openings, or jig assembly slots. Jig stops are provided that are individually adjustable along these openings by adjustable jig stop assemblies. Each adjustable jig stop assembly is movable by a lead screw driven by a power-operated device or a manual hand crank. Each lead screw is rotated a predetermined amount to position its jig stop at a predetermined location across the assembly table in accordance with a specified truss design. A counter can be connected to accurately monitor the position of each jig stop. This arrangement is too expensive for many manufacturers and requires maintenance of the gearing and power systems.

U.S. Pat. No. 5,085,414 to Weaver, which is incorporated by reference in its entirety, discloses a jigging system for forming trusses which includes a block design to fit within the rails of a C-shaped channel that extends along the length of the surface of a truss table. A jig stop is connected to the block. The jig stop can be moved along the length of the C-channel and fixed at a predetermined location. A measuring scale fits atop and extends along the length of one of the C-channel rails, and a pointer extends from the block toward the scale to provide the operator with a reference point for positioning the jig during set-up.

Another set-up jig design suggested for use with steel-topped tables is illustrated in U.S. Pat. Nos. 5,385,39 and 6,205,637 to Williams which are both incorporated by reference in their entirety. The Williams set-up jig is a steel block having a recess on its lower surface that mates with a thin metal ruler that extends across the length of the truss table. The steel block slides upon the ruler and is fixed into a predetermined position by a bolt inserted through a laterally positioned aperture in the block and into one of the grid holes of the truss table. These jigging systems have fixed rulers that are susceptible to becoming bent, moved out of position or worn beyond legibility. Once the rulers are beyond practical use, they can be difficult to replace.

It has been suggested that a laser image of the truss or jig stop positions be projected onto the table surfaces, as in U.S. Pat. No. 5,388,318 to Petta and U.S. Pat. No. 6,317,980 to Buck, both of which are incorporated herein by reference in their entirety. The use of an overhead imaging system is quite expensive and is not practical for many truss manufacturers. In addition, the laser image can be difficult to discern unless the truss manufacturing facility is kept quite dark, a working condition that can be difficult or even dangerous. These deficiencies render imaging systems inadequate for many manufacturers.

In view of the foregoing, it is an object of this invention to provide a system for placement of movable jigs on a truss assembly table which is easy to perform, accurate, inexpensive and can be repeated without degradation of the accuracy of jig stop placement.

### SUMMARY OF THE INVENTION

The jig stop placement assembly presented herein comprises a truss assembly table having a table top, the table top having a work surface and a plurality of jig assembly slots extending laterally across the table top. A plurality of jig stop assemblies are provided, each jig stop assembly movable along a jig assembly slot. Each jig stop assembly has a jig stop extending above the work surface of the table top. A jig stop placement assembly having an energy-emitting distance measuring device is provided for determining the distance between a jig stop and a reference piece or point. The energy-emitting device is preferably a laser device capable of emitting a laser beam. The beam of energy, regardless of type, should be emitted in a line approximately parallel with the table surface. The measurement device provides information regarding the distance between the jig stop and the reference piece which enables the user to accurately place the jig stop in a desired location.

The jig stop placement assembly preferably includes a jig stop alignment mechanism for positioning the placement assembly into a predetermined relationship with a jig stop, the truss assembly table, the reference piece or any combination thereof. In one embodiment, the jig stop alignment mechanism has a jig stop alignment surface for positioning in abutment with a jig stop. The jig stop alignment mechanism can be the edge of the placement assembly body or a plate. For example, the body can have a cylindrical or semi-circular surface which mates with the side wall of the jig stop. Where a mating surface is used, the surface preferably defines an alignment center point which is designed to correspond to the center of the jig stop when the alignment surface is positioned in abutment with the jig stop. The jig stops can be automatically movable or movable by hand.

The placement assembly preferably includes a lateral alignment mechanism. The lateral alignment mechanism can simply comprise an elongated block mounted to the bottom of the placement assembly and designed for positioning in a jig assembly slot. The lateral alignment mechanism works to align the beam of energy emitted from the measurement device in a line substantially parallel to the jig assembly slot.

The reference piece is placed at a pre-selected location for reflecting the energy emitted from the distance measuring device. The reference piece can be a member mounted specifically for that purpose or may comprise a portion of the truss assembly table. For example, the side rails can be used as reference pieces where the truss assembly table has side rails mounted on the table surface for use in conjunction with a roller press, the roller press operable to move along the length of the truss assembly table and press nail plates into truss members assembled on the work surface.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The accompanying drawings are incorporated and form a part of the specification to provide illustrative examples of the present invention. These drawings together with the description serve to explain the principles of the invention. The drawings are only for purposes of illustrating preferred and alternate embodiments of how the invention can be made and used and are not to be construed as limiting the invention to only the illustrated and described examples. Various advantages and features of the present invention will be apparent from the consideration of the accompanying drawings. For a more complete understanding of the present invention, and the advantages thereof, reference is now made to the following descriptions taken in conjunction with the accompanying drawing, in which:

FIG. 1 is a top plan view of a partial truss assembly apparatus with a truss assembly;

FIG. 2 is a continuation of FIG. 1, a top plan view of a partial truss assembly apparatus with a truss assembly;

FIG. 3 is a continuation of FIG. 2, a top plan view of a partial truss assembly apparatus with a truss assembly;

FIG. 4 is a top view of a jig stop placement assembly;

FIG. 5 is a front view of jig stop placement assembly; and

FIG. 6 is a top plan view of a jig stop placement assembly and a portion of a truss assembly table with jig assembly slot and jig stops.

### DETAILED DESCRIPTION OF ILLUSTRATIVE EMBODIMENTS

The present invention will be described by referring to drawings of examples of how the invention can be made and used. Like reference characters are used throughout the several figures of the drawing to indicate like or corresponding parts.

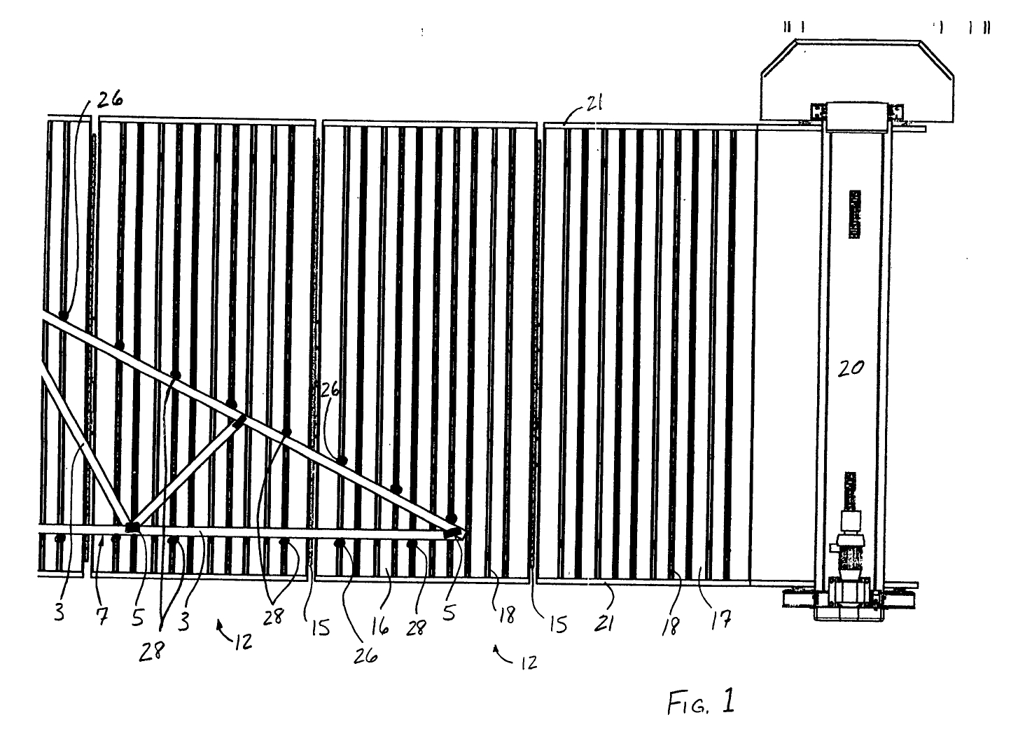

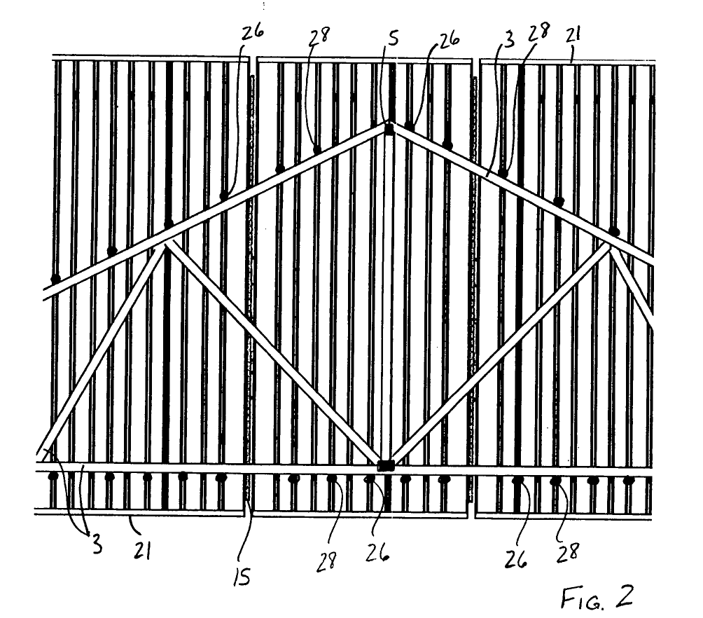

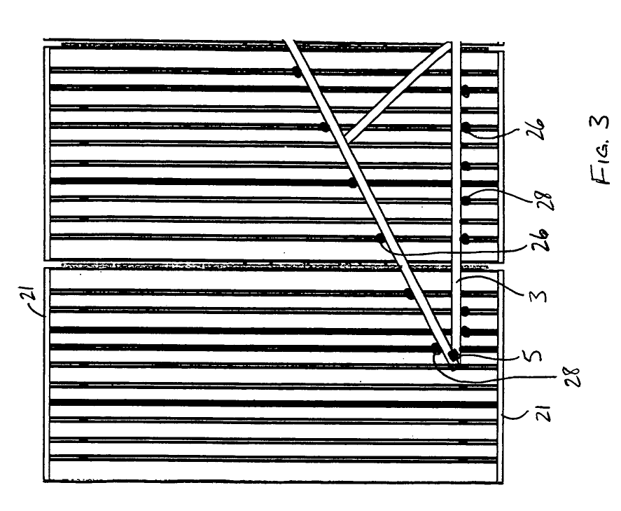

Referring now to FIGS. 1 to 3, one example of a truss assembly apparatus 10 is shown in sectional views. The apparatus 10 is of a type utilized to assemble a plurality of wooden members 3 with metal connector plates 5 to form a truss 7. The apparatus 10 is shown with separate table sections 12. It is to be understood that additional or fewer table sections can be used in the apparatus 10. The table sections are positioned in parallel alignment and preferably separated by gaps 14 having vertically displaceable lift-out arms 15 aligned therewith for lifting a finished truss from the apparatus 10.

Each of the table sections 12 have rigid support frames (not shown) that support a flat. It is to be understood that additional or fewer jig assembly slots 18 can be used on each of the table sections 12, and that the number and size of the slots 18 is not critical to the practice of the present invention.

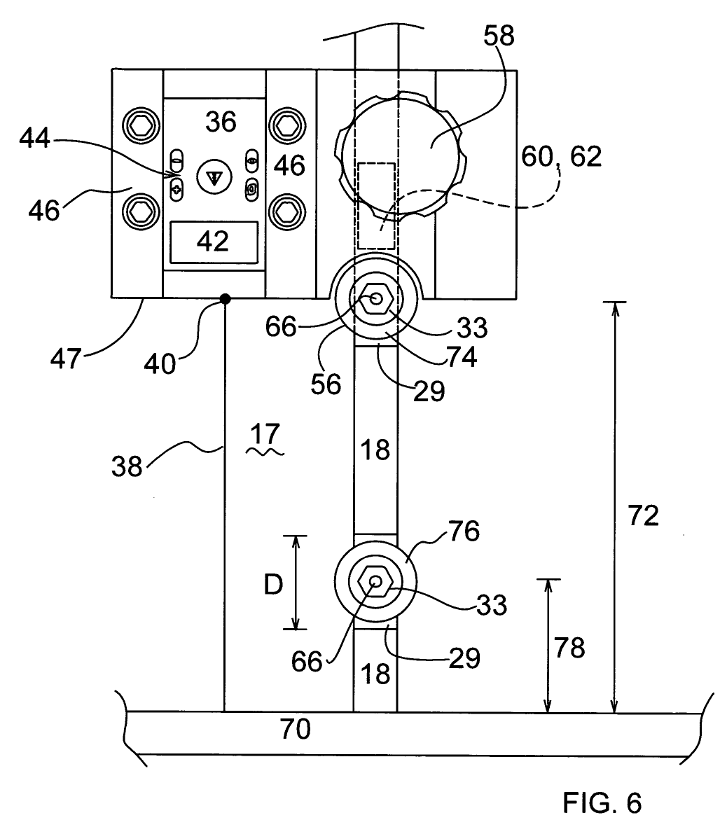

At least one laterally adjustable jig stop assembly 26 is located in each of the slots 18. When adjusted, a plurality of these jig stop assemblies 26 position jig stops 28, which are used in the alignment and layout of the beams 3 making up a desired configuration for a truss 7. Jig stops 28 extend vertically above the work surfaces and are typically cylindrical in shape. The jig stop assemblies can be clamped in place in any manner known in the art. In a typical jig stop assembly 26, the jig stop 28 is connected to a nut 29 located below the work surface 17 by a threaded bolt shank. The jig assembly can be clamped in place at a desired location along slot 18 by tightening the bolt and nut assembly. Typically the jig assembly is clamped by turning a bolt head 33 shown in FIG. 6, which may be counter-sunk in the top of the jig stop 28. Other arrangements known in the art may be employed. The jig assemblies may be tightened using a ratchet or other hand operated or automatic tool.

The truss assembly apparatus is shown with a roller press 20. The roller press 20, or gantry press, moves along the length of the truss table and presses connectors 5 into members 3. The roller press 20 can be of various design, floor or table mounted, with single or multiple rollers. The specifics of the press are not critical to the invention. Presses are described in detail in, for example, U.S. Pat. No. 6,612,230 to McAdoo, U.S. Pat. No. 5,933,957 to Haase, U.S. Pat. No. 5,211,108 to Gore and others, which are incorporated herein by reference for all purposes. The press 20, shown, has a roller which rolls along side rails 21 mounted on the table. The roller contacts the side rails 21 when operating along a section of table not having a truss 7 assembled thereon. The side rails 21 extend above the table surface, in one preferred embodiment, by approximately one and one-half inches. As will be explained herein, the side rails 21 may be used as reference pieces 70 for use in conjunction with the distance measuring device 36.

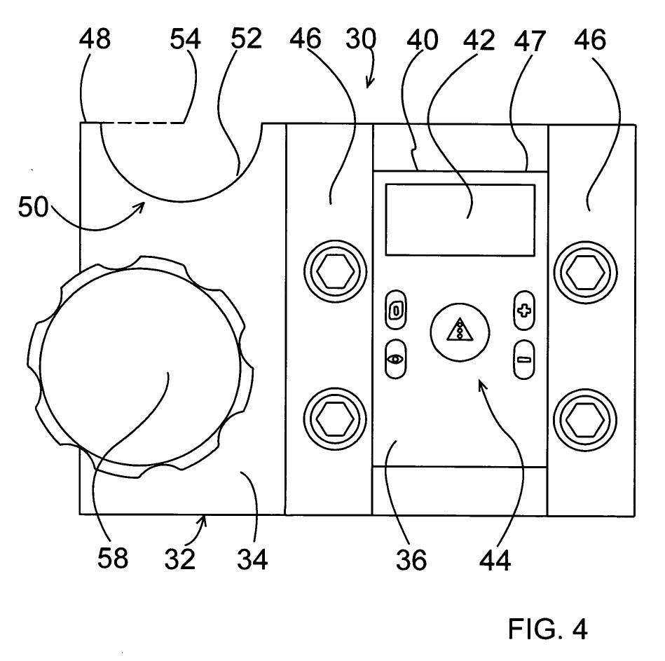

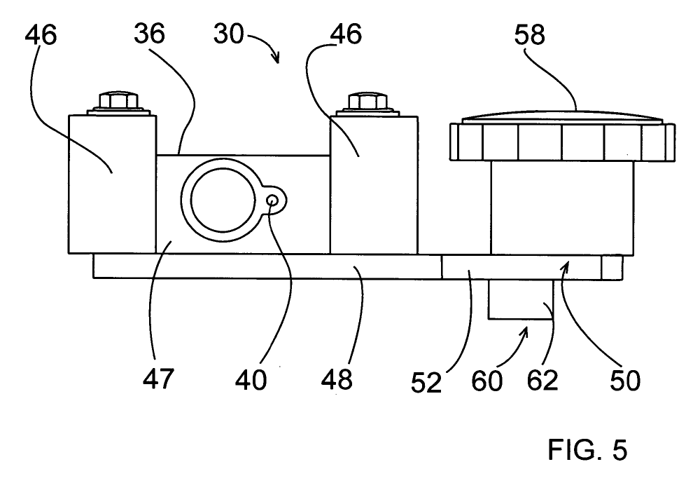

Placement of the jig stops 28 is achieved by use of a jig stop placement assembly 30, shown in FIGS. 4 and 5. The assembly 30 has a body 32, in this embodiment including a plate 34, upon which an energy-emitting distance measurement device 36 is mounted. The assembly includes at least one alignment mechanism for aligning the distance measuring device properly with respect to the table, a jig stop, a reference piece or any combination of these items. The placement assembly 30 is shown having a handle 58 for ease of use.

The energy-emitting distance measuring device 36 is preferably a laser emitting device, as shown. Other energy emitting devices, such as radar or sonar or other known devices, may be used, however a laser device is preferred for its accuracy. Such laser distance measuring devices or range meters are known in the art and are commercially available, for example, from Hilti Corporation (tradename) as models PD28 or PD30. Such devices are available to meet a wide range of specifications. Preferably, the laser range meter is capable of accurate measurements to within one thirty-second or on sixteenth of an inch and operates from very close to an object, for example, within a couple of inches, to distances up to the width of the truss assembly table. Range meters of this type are available with accuracy in measuring distances up to at least 200 yards. Sonar and other energy-emitting devices are also commercially available.

Turning now to FIGS. 4-6, the energy-emitting distance measuring device 36 emits an energy beam 38, in this case a laser beam, from a point of emission 40. In the preferred embodiment, the emission point is at the front face 47 of the measuring device. The beam will, of course, be emitted in a straight line. The beam progresses until encountering a solid object where it is reflected back to the device. The device measures distance based on readings from the reflected beam and displays the measured distance on the display screen 42. Operating controls 44 are used to operate the device.

The distance measuring device 36 is mounted to the body plate 34 by mounting assembly 46. A simple mounting assembly 46 is shown using bolts and braces designed to attach the measuring device securely to the plate 34. Other attachment mechanisms may obviously be used. The method of attachment is not critical to the invention.

The placement assembly body 32 has a front edge 48. Jig stop alignment mechanism 50 is provided for aligning the placement assembly in relation to a jig stop 28. In one embodiment, the jig stop alignment mechanism 50 is a jig stop alignment surface 52 designed to mate with the exterior 56 of a jig stop 28. The surface 52 can be cylindrical or semi-circular, as shown, although other shapes may be used. Where the surface 52 is semi-circular, the portion of the circle defines an alignment center point 54. Preferably, the front edge 48 of the assembly body 32 is aligned vertically with the emission point 40. Other jig stop alignment mechanisms may be used without departing from the spirit of the invention. One of the purposes of the jig stop alignment mechanism is to ensure that the placement assembly is placed into a predetermined spatial relationship with the jig stop. This insures that the measurement taken by the measuring device can be used to accurately measure the distance of the jig stop from a reference piece or reference point.

The assembly 30 also preferably has a lateral alignment mechanism 60. In one embodiment, the lateral alignment mechanism 60 comprises a longitudinal block 62 mounted to the bottom of the body plate 34. The block 62 is of a size to fit into a laterally extending jig assembly slot 18, as will be explained herein. The placement assembly has a height, not including the block 62, of preferably less than one and one-half inch. In this way, if the placement assembly is accidentally left on the table surface with the block inserted into a jig assembly slot when the press is operated, the placement assembly will not be damaged by the roller press.

FIG. 6 is a top view of the placement assembly 30 in place on a truss assembly table surface 17. Plate 34 is placed flush with the table surface 17. Jig stop alignment mechanism 50 is placed into abutment with the exterior of the jig stop 28. In a preferred embodiment, as shown, the jig stop alignment surface 52 is contoured to nest with the exterior of the jig stop 28. Also note that in this preferred embodiment, the alignment center point 54 corresponds to the center 66 of the jig stop 28. Lateral alignment mechanism 60 operates to align the energy beam 38 parallel to the jig assembly slot 18. Elongated block 62 fits into jig assembly slot 18 forcing the placement assembly into an appropriate position such that the energy beam is aligned as desired. The measuring device 36 should be aligned to direct an energy beam 38 parallel to the table surface 17 when the placement assembly 30 is placed flush to the work surface.

With the placement assembly in place, with the jig stop alignment mechanism 50 and lateral alignment mechanism 60 in place as designed, an accurate measurement can be taken and used to determine the distance of the jig stop 28 from the reference piece 70. The energy beam 38 is emitted along a line parallel to the jig assembly slot 18 ensuring that the distance measured by the measuring device, the distance from the emission point to the reference piece, is the same as the distance along a parallel line from the front edge 48 of the plate 34 to the reference piece 70. Since the front edge 48 of the plate 34 is aligned with the alignment center point 54, and the alignment center point 54 and the center 66 of the jig stop 28 correspond, the distance 72 from the center of the jig stop 28 to the reference piece 70 is the same as the distance measured by the measurement device 36.

The placement assembly 30 can be used to position multiple jig stops 28 mounted movably along a single jig assembly slot 18. For example, the placement assembly can be used to position the upper jig stop 74 at a selected distance 72 from the reference piece 70. The placement assembly can then be moved into position with jig stop alignment mechanism abutting lower jig stop 76 and lateral alignment mechanism 60 inserted into the jig assembly slot 18. Lower jig stop 76 can then be positioned a selected distance 78 from the reference piece 70.

The placement assembly is small and easily portable and can be used repeatedly to place any number of jig stops 28 in any number of jig assembly slots 18 into desired positions with relation to the reference piece 70 for forming a pattern selected for assembly of a truss.

In practice, a desired truss assembly pattern is known and the location for each jig stop is calculated. This can be done by hand, on a truss assembly drawing, or by computer. Once the desired locations of the jig stops is known, it is an easy matter to determine the distance the center 66 of each jig stop 28 should be from the reference piece 70. In the embodiment shown, the diameter D, and therefore the radius, of the jig stop is known. The desired distance from the center of a jig stop to the reference piece for any given truss assembly design will be a function of the clearance distance between the lower jig stop, such as lower stop 76, and the reference piece, a jig stop diameter or radius, and the geometry of the truss assembly. The distance each jig stop 28 should be placed from the reference piece can then be calculated.

In a preferred embodiment, the reference piece 70 is a side rail 21 which runs the length of the truss assembly table. However, other reference pieces 70 or points can be used without departing from the spirit of the invention. For example, a reference piece or pieces can be mounted on the truss assembly table for specifically that purpose. Alternately, other portions of the truss assembly table may be used as reference pieces. It is preferred that the reference piece run perpendicular to the jig assembly slots 18 such that the reference piece is always the same lateral distance from jig stops 28 placed in a longitudinal line with one another.

The placement assembly is placed into position against each jig stop 28 as explained herein and the distance measuring device is activated using controls 44. The distance measuring device emits a beam 38 which reflects off of the reference piece 70 and back to the device. The measurement device shows the measured distance from the emission point to the reference piece 70 on the display screen 42. The user moves the jig stop 28 along the jig assembly slot 18 into a position at the desired distance 72 from the reference piece 70. The jig stop assembly 26 is then clamped into position by the user. Multiple jig stops on a single jig assembly slot 18, such as upper jig stop 74 and lower jig stop 76, may be placed into position using the placement assembly 30. Similarly, the remaining jig stops 28 along the truss assembly table are placed into position.

Note that different arrangements can be provided for the emission point 40, edge of the placement assembly 48 and alignment mechanism 50. For example, the front edge 48 of the placement assembly 30 could alternately be simply a straight edge, having no contoured surface 52 for nesting with a jig stop exterior. This would result in a slightly different calculation in determining the desired distance readings for positioning of the jig stops. In this case, the measured distance 72 from reference piece would be greater by the radius of the jig stop than the measured distance when employing the contoured surface 52 as explained above. Similarly, other arrangements of the jig stop alignment mechanism can be used. The same sort of adjustments to the desired measured distance can be made to accommodate any offset between the emission point and the edge of the placement assembly.

Distances may be calculated from more than one reference piece 70. For example, for a single truss assembly arrangement, the distance of a jig stop from the reference piece 70 along one table edge could be calculated as well as the distance of the same jig stop from the reference piece along the other table edge. With both of these distances calculated, it will be easy for multiple measurement assemblies to be used by multiple users without interference. For example, one user, standing on the ground along the table edge, could position lower jig stops using a placement assembly measuring the distance from the lower jig stops to the reference piece along that table edge. Simultaneously, another user, likely positioned on the table surface, could use another placement assembly to position the upper jig stops by measuring the distance from the upper jigs to the reference piece along the opposite side of the table.

The embodiments shown and described above are only exemplary. Many details are often found in the art and are are currently on the market and available to those in the trade. Therefore, many such details are neither shown nor described. Thus, it is not claimed that all of the details, parts, elements, or steps described and shown are invented herein. Even though numerous characteristics and advantages of the present inventions have been set forth in the foregoing description, together with the details of the structure and function of the invention, the disclosure is illustrative only, and changes may be made in the detail, especially in the matters of shape, size, and arrangement of parts within the principles of the invention to the full extent indicated by the broad and general meaning of the terms used in the attached claims.

The restrictive description and drawings of the specific examples above do not point out what an infringement of this patent would be, but are to provide at least one explanation of how to make and use the inventions. The limit of the inventions and the bounds of the patent protection are measured by and defined in the following claims. Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A jig stop placement assembly comprising:
a truss assembly table having a table top, the table top having a work surface and a plurality of jig assembly slots extending laterally across the table top;
a plurality of jig stop assemblies, each jig stop assembly movable along a jig assembly slot, each jig stop assembly having a jig stop extending above the work surface of the table top;
a jig stop placement assembly having an energy-emitting distance measuring device for determining the distance between a jig stop and a reference piece; and
the reference piece placed at a pre-selected location for reflecting the energy emitted from the distance measuring device.

2. An assembly as in claim 1 wherein the jig stop placement assembly further comprises a jig stop alignment mechanism for positioning the placement assembly into a predetermined relationship with a jig stop.

3. An assembly as in claim 2 wherein the jig stop alignment mechanism comprises a jig stop alignment surface for positioning in abutment with a jig stop.

4. An assembly as in claim 3, the jig stop placement assembly having a plate and wherein the jig stop alignment surface is an edge of the plate.

5. An assembly as in claim 4 wherein the jig stop alignment surface is a cylindrical surface.

6. An assembly as in claim 5 wherein the cylindrical jig stop alignment surface is a semi-circular surface.

7. An assembly as in claim 6 wherein each jig stop is circular and has a jig stop center point, and wherein the semi-circular alignment surface defines a portion of a circle having an alignment center point and wherein the alignment center point corresponds to the jig stop center point when the alignment surface is positioned in abutment with the jig stop.

8. An assembly as in claim 1 wherein the jig stop placement assembly further comprises a lateral alignment mechanism.

9. An assembly as in claim 8 wherein the lateral alignment mechanism comprises an elongated block designed for positioning in a jig assembly slot.

10. An assembly as in claim 9 wherein the jig stop placement assembly further comprises a plate, the elongated block mounted to the bottom surface of the plate.

11. An assembly as in claim 8 wherein the distance measuring device is capable of emitting a beam of energy and wherein the lateral alignment mechanism works to align the beam of energy substantially in parallel with the jig assembly slot.

12. An assembly as in claim 1 wherein the jig placement assembly further comprises a plate, the distance measuring device mounted to the plate.

13. An assembly as in claim 1 wherein the jig stop placement assembly has a height of less than one and one-half inches.

14. An assembly as in claim 10 wherein the jig placement assembly has a height not including the lateral alignment block, and wherein that height is less than one and one-half inches.

15. An assembly as in claim 1 wherein the distance measuring device emits a beam of energy substantially parallel with the table work surface.

16. An assembly as in claim 1 wherein the jig stop placement assembly has a front edge and wherein the distance measuring device has an energy emission point and wherein the front edge and the energy emission point are substantially aligned.

17. An assembly as in claim 7 wherein the distance measuring device has an energy emission point and wherein the emission point is substantially aligned with the alignment center point such that each point is substantially the same lateral distance from the reference piece.

18. An assembly as in claim 1 further comprising a roller press operable to move along the length of the truss assembly table and press nail plates into truss members assembled on the work surface.

19. An assembly as in claim 18 wherein the roller press rolls along side rails mounted on the table surface.

20. An assembly as in claim 19 wherein the reference piece is a side rail.

21. An assembly as in Clam 1 wherein the truss assembly table further comprises at least one side rail mounted thereon, and wherein the reference piece is a side rail.

22. An assembly as in claim 1 wherein each jig stop assembly further comprises a threaded bolt shaft, the jig stop attached to the shaft, and a nut positioned below the truss table top and threadedly attached to the bolt shaft.

23. An assembly as in claim 22 wherein the nut is rectangular.

24. An assembly as in claim 1 wherein the jig stop assemblies are movable by hand.

25. An assembly as in claim 1 wherein the jig stop assemblies can be clamped into a set position by hand.

26. An assembly as in claim 1 wherein the energy emitted by the distance measuring device is a laser.

27. An assembly as in claim 1 wherein the reference piece further comprises a reference surface for reflecting a beam of energy emitted from the distance measuring device.

28. An assembly as in claim 1 wherein the reference piece is mounted to the truss assembly table.

29. An assembly as in claim 1 further comprising a second reference piece, the reference pieces mounted along opposite sides of the truss assembly table.

30. A jig stop placement assembly for use with a truss assembly table for positioning a movable jig stop, the assembly comprising:
an assembly body;
a laser-emitting distance measuring device mounted on the body, the device for determining the distance between a jig stop and a reference piece, the device capable of emitting a laser beam;
the reference piece placed at a pre-selected location for reflecting the energy emitted from the distance measuring device; and
an alignment mechanism on the body for aligning the laser beam in a selected orientation.

31. An assembly as in claim 30, the alignment mechanism for positioning the placement assembly into a predetermined relationship with respect to a jig stop.

32. An assembly as in claim 30, the alignment mechanism for positioning the placement assembly into a predetermined relationship with respect to the truss assembly table.

33. An assembly as in claim 30, the alignment mechanism for positioning the placement assembly into a predetermined relationship with respect to the reference piece.

34. An assembly as in claim 31, an alignment mechanism for positioning the placement assembly into a predetermined relationship with respect to the truss assembly table.

35. An assembly as in claim 31, an alignment mechanism for positioning the placement assembly into a predetermined relationship with respect to the reference piece.

36. An assembly as in claim 34, an alignment mechanism for positioning the placement assembly into a predetermined relationship with respect to the reference piece.

37. An assembly as in claim 31 wherein the jig stop alignment mechanism comprises a jig stop alignment surface for positioning in abutment with a jig stop.

38. An assembly as in claim 37, wherein the jig stop alignment surface is an edge of the plate.

39. An assembly as in claim 38 wherein the jig stop alignment surface is a cylindrical surface.

40. An assembly as in claim 39 wherein the cylindrical jig stop alignment surface is a semi-circular surface.

41. An assembly as in claim 40 wherein the semi-circular alignment surface defines a portion of a circle having an alignment center point and wherein the alignment center point corresponds to a jig stop center point when the alignment surface is positioned in abutment with the jig stop.

42. An assembly as in claim 30 wherein the jig stop placement assembly further comprises a lateral alignment mechanism for aligning the laser beam with a lateral jig assembly slot on the truss assembly table.

43. An assembly as in claim 42 wherein the lateral alignment mechanism comprises an elongated block designed for positioning in the jig assembly slot.

44. An assembly as in claim 43 further comprising an elongated block mounted to the body.

45. An assembly as in claim 43, wherein the elongated block width is substantially the same width as the jig assembly slot.

46. An assembly as in claim 30 wherein the jig stop placement assembly has a height of less than one and one-half inches.

47. An assembly as in claim 43 wherein the jig placement assembly has a height not including the lateral alignment block, and wherein that height is less than one and one-half inches.

48. An assembly as in claim 30 wherein the distance measuring device emits a beam of energy substantially parallel with a work surface of the table.

49. An assembly as in claim 32 wherein the alignment mechanism positions the distance measuring device such that the laser beam emitted therefrom is substantially parallel with a work surface of the table.

50. An assembly as in claim 30 wherein the body has a front edge and wherein the distance measuring device has an energy emission point and wherein the front edge and the energy emission point are substantially aligned.

51. An assembly as in claim 41 wherein the distance measuring device has an energy emission point and wherein the emission point is substantially aligned with the alignment center point such that each point is substantially the same lateral distance from the reference piece.

52. An assembly as in claim 30 wherein the truss assembly table further comprises side rails for use with a roller press operable to move along the length of the truss assembly table and press nail plates into truss members assembled on the work surface.

53. An assembly as in claim 52 wherein the reference piece is a side rail.

54. An assembly as in claim 30 wherein the reference piece further comprises a reference surface for reflecting the laser beam emitted from the distance measuring device.

55. An assembly as in claim 54 wherein the reference surface is mounted on the truss assembly table.

56. An assembly as in claim 55 wherein the reference surface is mounted on a jig stop.

57. An assembly as in claim 30 further comprising a second reference piece.

58. An assembly as in claim 57 wherein the reference pieces comprise side rails, one mounted on each side of the truss assembly table.

59. An assembly as in claim 58 wherein the jig placement assembly is designed to measure the distance from a jig stop to either side rail.

60. An assembly as in claim 30 wherein the assembly is designed to be positioned at the side of the truss assembly table.

61. An assembly as in claim 60 wherein the reference piece is a portion of the truss assembly table and the laser beam is reflected off of the jig stop or a surface mounted on the jig stop.
